(19) United States
(12) Patent Application Publication
(10) Pub. No.: US 2008/0000948 A1
(43) Pub. Date: Jan. 3, 2008

(54) Vent Closing Method And The Use Of An Ultrasonic Bonding Machine For Carrying Out The Method

(76) Inventors: Henri Blanc, Grenoble (FR); Stephane Caplet, Sassenage (FR)

Correspondence Address: OLIFF & BERRIDGE, PLC, P.O. BOX 320850, ALEXANDRIA, VA, 22320-4850, US

(21) Appl. No.: 11/587,241

(22) PCT Filed: May 3, 2005
(86) PCT No.: PCT/FR05/01125

§ 371 Date: Oct. 23, 2006

(30) Foreign Application Priority Data
May 12, 2004 (FR) 0405128

(51) Int. Cl. B23K 20/10

(52) U.S. Cl. 228/110.1

(57) ABSTRACT

The inventive method for closing a vent (9) formed in a microstructure (3) wall (10) under a controlled atmosphere is carried out by an ultrasonic bonding machine comprising a welding electrode (14), a metal wire (13) crossing the electrode (14) and a working table (15). A ball (12) is formed by melting on the end part of the metal wire (13) and is deposited on the end of the vent (9) and a holding plug (11) and is subsequently exposed to compression forces (F) and ultrasonic vibration (Fᵤₛ) by the electrode (14) in a controlled atmosphere chamber (17).

### BACKGROUND OF THE INVENTION

The invention relates to a method for closing a vent formed in a wall of a microstructure in a controlled atmosphere.

The invention also relates to the use of a machine for implementing this method.

### STATE OF THE ART

Operation of certain components, particularly in the microelectronics field, imposes control of the environing atmosphere. This is the case for example for microdetectors (infrared microbolometers) or for certain MEMS components (RF microswitches).

For example, MEMS devices produced collectively on silicon wafers generally contain mobile elements forming electrical, mechanical or optical assemblies. These devices are in all cases fragile and fabrication thereof therefore integrates an encapsulation step the function whereof is at least to ensure mechanical protection of the sensitive parts. This encapsulation is sometimes an integral part of the device supporting electrodes, contact pads, or mechanical stops in the direction perpendicular to the plane of the wafer.

Encapsulation of the devices in a controlled atmosphere, i.e. in a vacuum or in a gaseous atmosphere, conventionally consists in forming a microstructure delineating a cavity around the device, drilling a vent in a wall of the microstructure and then reclosing the vent with a plug, after placing the device in a controlled atmosphere. As represented in FIG. 1, a microcomponent according to the prior art comprises at least one elemental device 1, fabricated beforehand on a substrate 2. A microstructure 3 is then fabricated around the device 1, for example by means of a resin mold, with a wall 4 delineating a cavity 5 around the device 1 to be encapsulated. A small hole 6, called a vent, is then formed in the wall 4 of the microstructure 3 to remove the resin which acted as mold and create a vacuum inside the cavity 5. The vent 6 is then sealed off by depositing a sealing material, while maintaining the vacuum in the cavity 5.

The major difficulty of this type of process lies in obtaining hermetic closing of the microstructure 3, while controlling the atmosphere inside the latter.

It has already been proposed to use a technique of metal deposition by evaporation to perform sealing of a vent (FIG. 2). Metal depositions by evaporation (vacuum deposition) are in fact the most suitable depositions for performing control of the microstructure atmosphere. However, hermetic tightness of the microstructure is not guaranteed. As represented in FIG. 2, the tightness of the vent 6 is not always optimum after sealing has been performed. Zones corresponding to breaks in the slope of the cavity 5 may in fact remain between the wall 4 and the substrate 2, where the sealing material 7 is not completely compact and may present openings 8.

It is also known to seal the vents by a dielectric by Plasma Enhanced Chemical Vapor Deposition (PECVD). In this case, the tightness of the microstructure is better, but the atmosphere in the microstructure cannot be controlled, as the gases formed when PECVD is performed are present in the microstructure at the time closing is performed.

There is no known deposition technique combining good tightness characteristics and control of the atmosphere. In the case of PECVD, the tightness is good, but it is not possible to control the atmosphere. When using the metal evaporation technique, the atmosphere can be controlled, but the tightness of the microstructure is not well ensured.

Moreover, the microstructure only represents very small volumes, the thickness and surface of the microstructure being very limited. This succession of steps therefore presents the drawback of having recourse to sensitive and delicate methods.

Furthermore, a plurality of microstructures to be sealed are generally disposed on the same plate, also called wafer. The microstructures therefore have to be separated to be able to encapsulate them in individual housings. It is in general at the time when encapsulation is performed that the microstructures are placed in a controlled atmosphere, via the vent which then remains open. In this case, during cutting of the wafer, the vents may have to be temporarily sealed, for example by applying a plastic film on the drilled face, to prevent any water and debris originating from sawing from getting in.

The final component encapsulated in housing therefore presents a large cost and the difficulty of the steps of creating the vacuum and of individual housing in a chip remains a problem.

### OBJECT OF THE INVENTION

It is an object of the invention to remedy these shortcomings and to provide a vent closing method that is simple and efficient and can be applied indifferently on a single microstructure or on a whole wafer equipped with a plurality of microstructures.

According to the invention, this object is achieved by the accompanying claims and more particularly by the fact that the method comprises at least the following steps:

deposition of a securing pad on the wall at the periphery of one end of the vent,

formation of a ball by melting at one end of a metal wire,

deposition of the ball on the end of the vent and on the securing pad,

deformation of the ball and ultrasonic welding onto the securing pad.

It is a further object of the invention to provide an ultrasonic welding machine for implementation of the sealing method.

### BRIEF DESCRIPTION OF THE DRAWINGS

Other advantages and features will become more clearly apparent from the 20 following description of particular embodiments of the invention given as non-restrictive examples only and represented in the accompanying drawings, in which:

FIG. 1 schematically represents a microstructure with a vent according to the prior art.

FIG. 2 represents a vent sealed by a metal deposition by evaporation method according to the prior art.

FIGS. 3 and 4 schematically represent two steps of a vent sealing method according to a first embodiment of the invention.

FIGS. 5 to 10 schematically represent different steps of the vent sealing by means of an ultrasonic welding machine according to the invention.

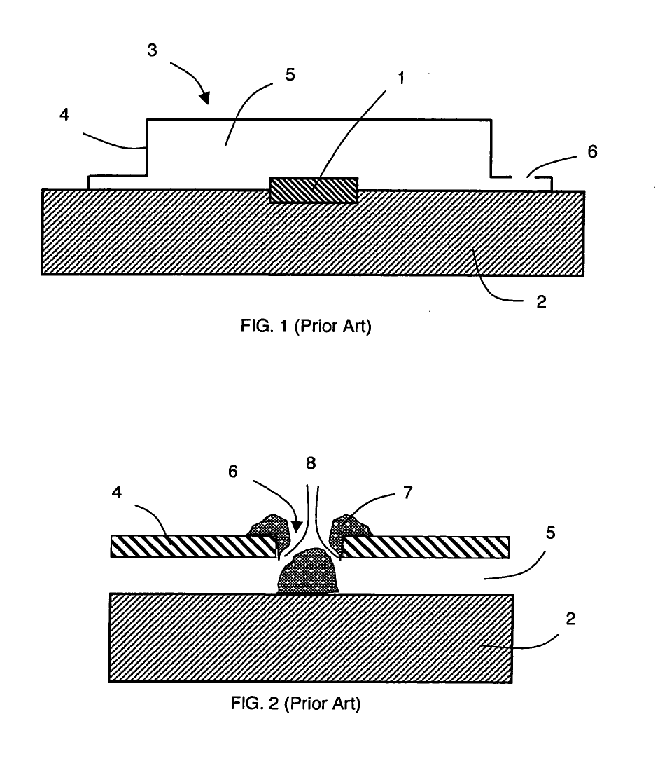

### DESCRIPTION OF PARTICULAR EMBODIMENTS

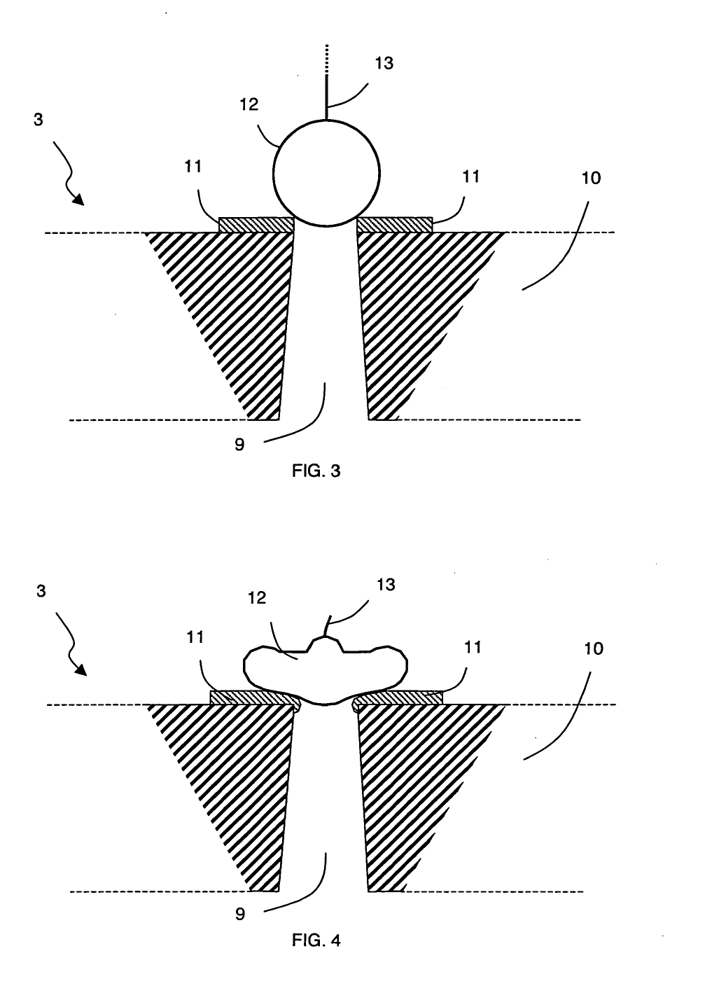

In FIGS. 3 and 4, a vent 9 is formed in a wall 10 of a microstructure 3 in a controlled atmosphere. The vent 9 has the shape of a truncated cone, but it can be of any other shape, in particular cylindrical. To close the vent 9, a first step consists in depositing a securing pad 11 on the wall 10 at the periphery of the vent 9, more particularly at the periphery of the end thereof that opens out opposite the cavity formed in the microstructure 3.

The securing pad 11 is achieved by deposition of a layer of metal chosen from gold, silver, aluminium or copper. The securing pad is preferably achieved by deposition of a layer of gold by means of a mask (not represented), so as to form a preferably annular pad around the hole formed by the vent 9.

In an alternative embodiment (not represented), the vent 9 can be achieved after deposition of the metal layer designed to form the securing pad 11, for example by laser etching.

In a second step, a ball 12 is formed by melting at one end of a metal wire 13. The metal wire 13 and the ball 12 can be made from ductile metal chosen from gold, silver, aluminium or copper. Advantageously, the ball 12 and the securing pad 11 are made of the same material to facilitate subsequent hardening thereof.

The ball 12 is then deposited on the end of the vent 9 and on the securing pad 11 (FIG. 3) and sealing of the vent 9 is then performed by deformation of the ball 12 and welding of the ball 12 onto the securing pad 11. A compression force F, or crushing force, is applied on the ball 12 by means of a welding electrode 14 (FIG. 8), so that the ball 12 is deformed and seals off the vent 9 pressing on the securing pad 11, as represented in FIG. 4. At the same time, vibrations, preferably low-amplitude ultrasonic vibrations, are generated by the welding electrode 14 to perform ultrasonic welding of the deformed ball 12 and the securing pad 11, at the level of the contact zones between the securing pad 11 and the deformed ball 12. The combination of the compression forces and of the vibration forces causes deformation of the ball 12 and welding thereof onto the securing pad 11.

After the ball 12 has been welded (FIG. 4), if tensile strength testing is carried out, breaking takes place at the level of the metal wire 13, just above the deformed ball 12, and not at the level of the securing pad 11. The metal wire 13 can thus be eliminated, for example, by traction thereupon. A residual bit of wire 13 may remain joined to the top part of the deformed ball 12.

The method described above is performed at a temperature that is preferably about 150° C., which is much lower than the melting temperature of gold, silver, aluminium and copper, in order to facilitate deformation and welding of the ball 12. Crushing the ball 12 enables a perfect contact of the ball 12 on the securing pad 11 to be obtained, with in addition a definitive mechanical junction. Sealing is therefore perfectly hermetic. Moreover, gold is the most suitable for performing this hermetic sealing function, as it is very ductile. The bond thus obtained is not only mechanical but also constitutes an electrical connection, as gold also presents a good conductivity.

If required, an additional oxidization step of the wall 10 of the microstructure 3 can be included. An oxidized layer (not shown) is then formed between the wall 10 and the securing pad 11. The oxidized layer has the function of insulating the securing pad 11 electrically from the wall 10.

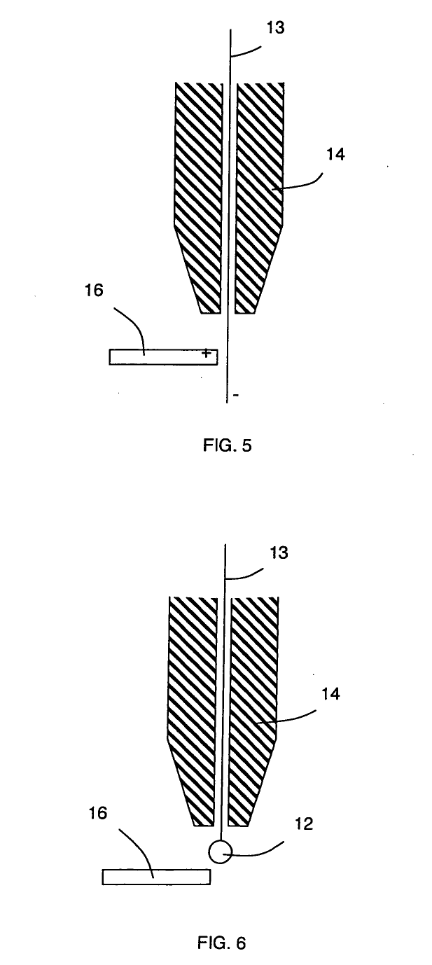

The vent sealing method described above can be implemented by means of an ultrasonic welding machine, described in greater detail with regard to FIGS. 5 to 10. An ultrasonic welding machine conventionally comprises a welding electrode 14, wherethrough the metal wire 13 passes, and a working table 15.

As represented in FIGS. 5 and 6, the machine conventionally comprises means 16 designed for forming the ball 12 by melting the metal wire 13. A high voltage can for example be applied between the metal wire 13 and a terminal 16, making the wire 13 melt resulting in formation of the ball 12 which will then be hardened.

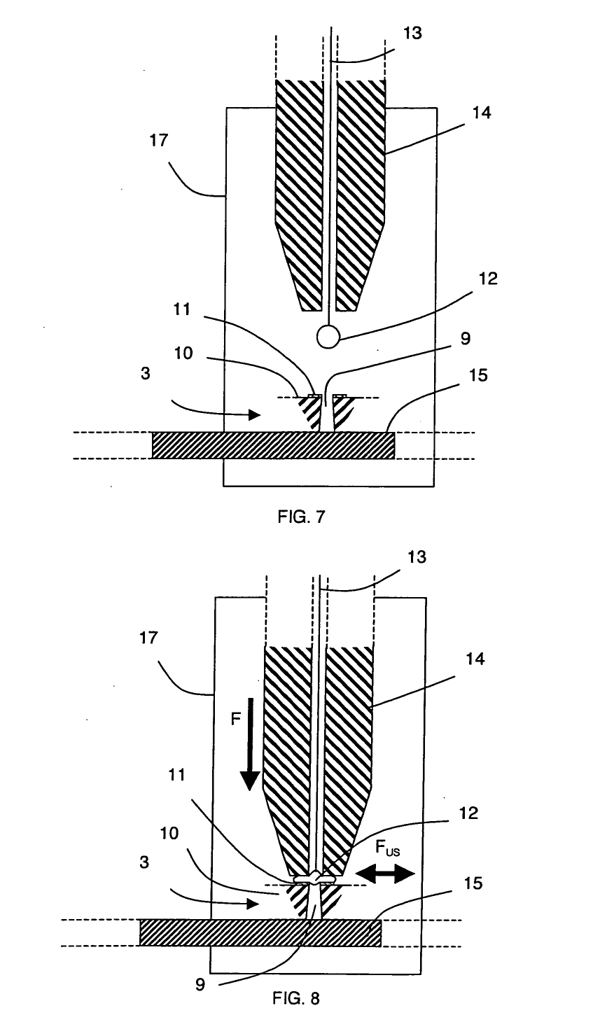

To implement the invention, the microstructure 3, provided with at least one vent 9 to be sealed, is placed on the working table 15 (FIGS. 7 to 10). In addition, the ends of the electrode 14 and of the metal wire 13 are placed in a chamber 17, the atmosphere whereof can be controlled. For example, a vacuum or a partial pressure of inert gas can be created in the chamber 17, after the ball 12 has been formed in the chamber 17.

The machine conventionally comprises means for moving the electrode 14 perpendicularly to the working table 15. The ball 12 can thus be deposited on the end of the vent 9 and on the securing pad 11 of the microstructure 3 supported by the working table 15. The machine also conventionally comprises means for generating ultrasounds, designed to cause a vibration of the welding electrode 14. The means for moving the electrode 14 and the means for generating ultrasounds are formed by any suitable means used in conventional ultrasonic welding machines.

In FIG. 8, the electrode 14 is moved so as to be brought into contact with the ball 12 and to apply a crushing force F on the ball 12, perpendicularly to the working table 15. This results in compression and deformation of the ball 12 on the securing pad 11 of the microstructure 3 and sealing of the vent 9. Applying an ultrasonic vibration force Fᵤₛ to the electrode 14 in contact with the ball 12, preferably in a direction parallel to the working table 15, results in the ball 12 being welded onto the securing pad 11.

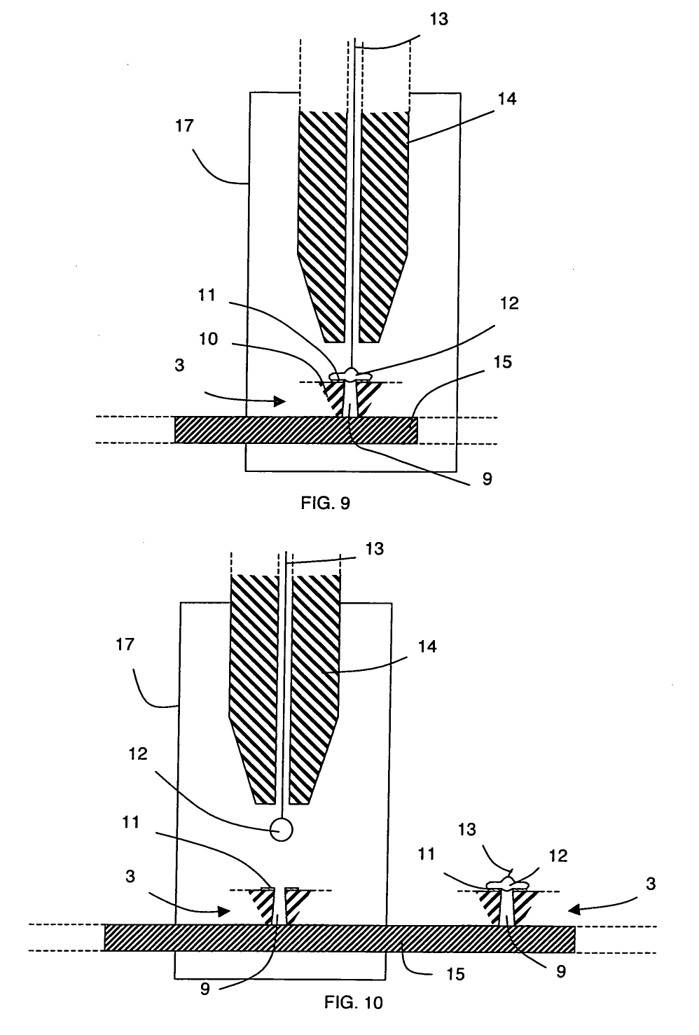

In FIGS. 9 and 10, welding has been performed and sealing of the vent 9 is terminated. The welding electrode 14 then reverts to its initial position, away from the microstructure 3, moving up perpendicularly to the working table 15 (FIG. 9). The metal wire 13 is then for example broken at the level of the deformed ball 12, for example by a tractive force exerted on the wire 13. A small bit of residual wire 13 may remain on the top surface of the deformed ball 12.

In an alternative embodiment (not represented), the welding wire 13 can be used to make an electrical connection by connecting the free end of the residual wire 13 to a connection pad of an encapsulation housing, or of another component. In another alternative embodiment, the metal wire 13 can be cut at the same time as the next ball 12 is formed to achieve automation of the sealing method.

The machine can comprise means for relative movement of the microstructure 3 and of the welding electrode 14, both perpendicularly to the working table 15 and parallel thereto. For example, the microstructure 3 can be securedly affixed to the working table 15, which can be in movement with respect to the welding electrode 14. The lateral movement of the working table 15 enables the microstructures 3 to be brought one after the other to a position under the welding electrode 14, in the chamber 17. In FIG. 10, the working table 15 supports, outside the chamber 17, a microstructure 3 the vent 9 whereof has already been sealed, and, in the chamber 17 of the machine, a microstructure 3 ready to be sealed.

The method according to the invention can thus be implemented for any known ultrasonic welding machine, the complementary means required for implementation of the vent sealing method, i.e. the controlled atmosphere chamber 17 and the means for moving the microstructure 3 inside the chamber 17, being easy to install and to use.

Furthermore, whole wafers comprising a plurality of microstructures 3 can be treated, and the vents be sealed before cutting of the whole wafer is performed. Large savings in terms of cost and time are therefore possible.

The vent sealing method and the ultrasonic welding machine described above procure in particular the following advantages, i.e. good hermetic sealing of the microstructure 3, an efficient sealing method performed at low temperature and easy to implement, and a welding machine enabling the sealing method to be applied for a unitary microstructure or for a plurality of microstructures made on a full wafer before the latter is cut.

The invention is more particularly interesting when fabrication of microstructures constituting accelerometers, bolometers, and RF or power microswitches is involved.

1. A method for closing a vent formed in a wall of a microstructure in a controlled atmosphere, comprising at least the following steps:
deposition of a securing pad on the wall at the periphery of one end of the vent,
formation of a ball by melting at one end of a metal wire,
deposition of the ball on the end of the vent and on the securing pad,
deformation of the ball and ultrasonic welding onto the securing pad.

2. The method according to claim 1, wherein deformation and ultrasonic welding of the ball are caused by a crushing force and by ultrasonic vibrations.

3. The method according to claim 1, wherein it is performed at a temperature of about 150° C.

4. The method according to claim 1, wherein the ball is made of ductile metal.

5. The method according to claim 4, wherein the metal is chosen from gold, silver, aluminum or copper.

6. The method according to claim 1, wherein the securing pad is achieved by deposition of a layer of metal chosen from gold, silver, aluminum or copper.

7. The method according to claim 1, wherein the ball and the securing pad are made from the same material.

8. The method according to claim 1, comprising an oxidation step of the microstructure before deposition of the securing pad.

9. (canceled)
